(19) United States
(12) Patent Application Publication
(10) Pub. No.: US 2005/0113253 A1
(43) Pub. Date: May 26, 2005

(54) Fertilizer

(76) Inventor: Paul Michael Ferrell, Sheffield Village, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/718,052

(22) Filed: Nov. 20, 2003

(51) Int. Cl. C05G 3/02

(52) U.S. Cl. 504/101

(57) ABSTRACT

A particulate fertilizer containing prodiamine is produced by impregnating the fertilizer with a solution of the prodiamine in N-methyl pyrrolidone.

### FIELD OF INVENTION

This invention relates to fertilizers, and especially to methods of producing fertilizers including herbicides and other agriculturally active compounds.

### BACKGROUND

Prodiamine [2,4-dinitro-N³,N³-di-n-propyl-6-(trfluoromethyl)-1,3-benzenediamine] is a widely used herbicide because of its high herbicidal activity against a broad spectrum of different plant types and its low toxicity towards animal life. It is commercially available as a crystalline solid in essentially pure form (technical grade, ˜90+ to 99.5% pure) as well as an air milled powder containing about 65 wt. % active ingredient and 35 wt. % of various clays and other proprietary ingredients, the powder typically having a particle size of 0.150 mm (0.0058 inches) or less.

Prodiamine is also available to the consumer in the form of prodiamine-impregnated lawn and other household fertilizers. These products are typically made by blending the fertilizer in particulate form with an appropriate amount of powdered prodiamine so that the prodiamine powder particles stick to the surfaces of particulate fertilizer. Normally, a small amount of mineral oil or other sticky substance is blended with the mix, or sprayed on the particulate fertilizer before blending with the prodiamine powder, to improve adhesion of the prodiamine powder to the particulate fertilizer.

However, prodiamine powder is flammable, and so such manufacturing processes are inherently dangerous. Accordingly, there is a need for a new manufacturing technique for producing prodiamine-impregnated fertilizers which avoids this problem.

### SUMMARY OF THE INVENTION

In accordance with the present invention, it has been found that this problem can be avoided by applying prodiamine to the particulate fertilizer in the form of a solution, emulsion or dispersion of the prodiamine in a suitable solvent, in particular N-methyl pyrrolidone or analog.

In particular, it has been found in accordance with the present invention that, not only does N-methyl pyrrolidone exhibit limited flammability and hence can be used without the fire risk inherent in earlier technology, but also prodiamine will dissolve in N-methyl pyrrolidone in sufficient concentration so that it can be applied to the particulate fertilizer by solution coating techniques in a cost effective way.

Thus, the present invention provides a process for producing a particulate fertilizer impregnated with prodiamine or other agriculturally active chemical in which the particulate fertilizer is contacted with a liquid impregnating composition comprising at least 5 wt. % of the agriculturally active chemical dissolved in N-methyl pyrrolidone or other analogous organic liquid carrier.

### DETAILED DESCRIPTION

Particulate Fertilizers

In accordance with the present invention, a particulate fertilizer is impregnated with prodiamine or other analogous agriculturally active compound (“AAC”).

In this process, essentially any known particulate fertilizer can be used as the substrate being impregnated. Examples are nitrogen-containing compounds such as urea and sulfur-coated urea, polymer coated urea, urea formaldehyde products, methylene urea (MDU & DMTU), isobutylidene diurea, animal matures, activated sewage sludge and ammonium sulfate; phosphorous-containing compounds such as phosphoric acid, phosphorous acid, diammonium phosphate, limestone, monoammonium phosphate, and triple superphospate; and potassium-containing compounds such as potassium nitrate, sulfate of potash, muriate of potash and potassium magnesium sulfate. Other ingredients can also included. Examples are iron-containing compounds such as ferric oxide, ferrous oxide and ferrous sulfate; magnesium-containing compounds such as magnesium carbonate, magnesium oxide and magnesium sulfate; manganese-containing compounds such as manganese oxide and potassium magnesium sulfate; and other ingredients such as copper, zinc, sulfur and chlorine. Various fillers and/or conditioners such as clays, limestone, corncobs, grain dusts, paper and other inert materials can also be included, both to aid in spreadability, i.e., the ability to distribute the product evenly, and to contribute to the desired N—P—K ratio.

These ingredients, and especially the compounds supplying nitrogen, phosphorous and/or potassium, can be included individually. In other words, the particulate fertilizer to be impregnated in accordance with the present invention can be composed of a mixture of different particulate fertilizers selected and compounded so that the resultant mixture as a whole provides the desired fertilizer composition. Alternatively, these ingredients can be supplied as pre-formed mixed particles, i.e., particulate materials in which the individual particles are formed from mixtures of these ingredients.

The particle size of the particulate fertilizer being impregnated in accordance with the present invention can vary widely, and essentially any particle size can be used. Typically, the particle size will be between about 6.5 mm (˜0.25 inch) to and 0.25 mm (˜0.01 inch). depending on application and customers' desire. The bulk density of the particulate fertilizer normally varies from about 0.05 to 1.5 gms/cc (˜3-90 lb. per cubic foot), with typical fertilizer blends having bulk densities of about 0.8 to 1.0 gms/cc (˜52-62 pound per cubic foot).

Prodiamine and Analogs

In accordance with the present invention, a particulate fertilizer as described above is impregnated with prodiamine or analog.

In this context, “analog” means another agriculturally active compound (“AAC”), i.e., a compound which is useful as an agricultural fertilizer, nutrient, plant growth accelerant, herbicide, plant growth controlling chemical, insecticide, bactericide, fungicide, nematocide, fumigant and the like. Specific examples are pendimethalin, benefin (balan), triflurin (Treflan) and Bifenthrin (Talstar insecticide). Other examples of such compounds are described in U.S. Pat. No. 5,160,528, the disclosure of which is incorporated herein by reference. Mixtures of such compounds can be used.

Mixtures of prodiamine and another AAC are especially interesting.

N-Methyl Pyrrolidone and Analogs

In order to impregnate a particulate fertilizer with prodiamine or analog in accordance with the present invention, the prodiamine or analog is dissolved in an organic liquid carrier and the composition so obtained applied to the surfaces of the particulate fertilizer.

The organic liquid used for this purpose should exhibit high solvency, low flammability and low toxicity. Thus, this organic liquid carrier should be capable of dissolving the AAC (i.e., prodiamine or analog) in concentrations of 5 wt. % or more, preferably 10 wt. % or more. In addition, it should have a flash point above ˜38° C. (100° F.). In addition, it should also have low toxicity as reflected by exhibiting a Primary Irritation Score under 16 CFR 1500.3(c)(4) of 5.00 or less, preferably 1.5 or less. N-methyl pyrrolidone is a preferred organic liquid carrier for use in the present invention, since it is can dissolve large amounts of prodiamine and other AAC's while exhibiting limited flammability and toxicity. In particular, N-methyl pyrrolidone has a flash point of ˜86° C. (187° F.) and a Primary Irritation Score under 16 CFR 1500.3(c)(4) of 0.5. Other pyrrolidones having a hydrogen or C₁₋₄ alkyl attached to the nitrogen of the pyrrolidone ring can also be used.

In addition to these pyrrolidones, other organic liquids having similar and/or better solvency, flammability and toxicity properties can also be used. That is, other organic liquids an also be used, provided that they are capable of dissolving at least 5 wt. % of the particular ACC chosen, and further provided that they have a flash point above ˜38° C. (100° F.) and exhibit a Primary Irritation Score under 16 CFR 1500.3(c)(4) of 5.00 or less.

For example lactones, which are cyclic esters in which the main ring has four to seven atoms, two of which are provided by the ester group (—CO—O—), can be used. Specific examples are β-propiolactone, β-butyrolactone, 4-hydroxy-3-pentenoic acid γ-lactone, γ-butyrolactone, γ-crotonolactone, γ-valerolactone, γ-caprolactone, δ-valerolactone and ε-caprolactone. In addition, organic esters having 6 to 10 carbon atoms, preferably 7, 8 or 9 carbon atoms, can also be used. Specific examples are isobutyl isobutyrate, propyl heptanoate and heptyl propionate. Other naturally-occurring esters, as well as propylene carbonate, can also be used.

Mixtures of these organic liquids can also be used.

Impregnating Composition

The impregnating composition used in the inventive process is prepared by dissolving the prodiamine or other ACC in the organic liquid carrier. This is done in a conventional way, using heating, mixing and other conventional means to aid dissolution as necessary.

For ease of application on a commercial scale, the impregnating composition should contain at least about 10 wt. % of prodiamine and/or other ACC, although concentrations as low as 5 wt. % or even less are still workable, the percents being based on the total weight of the impregnation composition. Solubility limits may dictate the maximum concentration of the prodiamine or analog, and therefore it is desirable to choose a liquid carrier for each application which is capable of dissolving the ACC to be used in sufficient concentration. In any event, concentrations as high as 50 wt. % or even 75 wt. % or more are normal.

For example, when N-methyl pyrrolidone is used as the liquid carrier for prodiamine, concentrations of 50 wt. % or more can be easily achieved by heating and gentle mixing. For convenience, however, concentrations on the order of 10 to 50 wt. %, and especially about 30 to 40 wt. %, are appropriate.

Additional liquid ingredients may also be included in the impregnating compositions of the present invention. For example, co-solvents may be included to aid in the solubility of the ACC in the organic liquid carrier. Examples are alcohols, mineral or paraffinic oils, and various types of aromatic solvents.

Water may also be included in appropriate circumstances to reduce the amount of organic liquid carrier being used. Water is miscible with, or highly soluble in, many of the organic liquid carriers of the present invention, and so water can be included in impregnating compositions made with these materials without special precaution. In addition, aqueous emulsions or dispersions of the AAC/liquid carrier solution in water can be prepared by including a suitable surfactant for this purpose in accordance with known techniques. Nonionic and especially silicone-based surfactants (wetting agents and dispersing agents) are particularly well suited for this purpose, although other types of surfactants can also be used.

Other conventional ingredients can also be included in the impregnating compositions of the present invention. For example, various dyes and other colorants can be added for marketing purposes (i.e., for brand identification) and to serve as spreader aids (i.e., for showing how much product has been applied). Where non-aqueous impregnating compositions are desired, a conditioning agent such as synthetic calcium silicate can be included, if necessary. Various clays such a montmorilloite, attapulgite and kaolin, as well as zeolites, talc, vermiculite, pumice, diamtomite and cellulose, can also be used for this purpose.

The liquid impregnating compositions of the present invention can also contain more than a saturation concentration of AAC, if desired. That is to say, the amount of AAC in the liquid impregnating composition can be more than the saturation concentration of that AAC in the particular organic liquid carrier being use, in which case some of the AAC will be present as precipitate or other undissolved form. In this case, surfactants and/or other chemicals can be included to keep the AAC dispersed in the liquid carrier, if desired.

Impregnation of the Fertilizer

Impregnation of the particulate fertilizer substrate can be carried out by any method capable of contacting the surfaces of the fertilizer particles with the above liquid impregnating composition. Many such techniques are known, and any such technique can be used. For example, the particulate fertilizer can be immersed in the liquid impregnating composition, or the liquid impregnating composition can be sprayed on the particulate fertilizer. Most conveniently, impregnation is done by spraying the impregnating composition onto a moving bed of the particulate fertilizer, as this technique facilitates both uniform application as well as precise control of the amount of AAC deposited.

The amount of liquid impregnating composition to be deposited on the particulate substrate, and hence the amount of AAC in the product fertilizer obtained, can vary widely and essentially any amount can be used. Of course, each AAC has its own rate of application (i.e., amount per unit area), while each particulate fertilizer to be impregnated also has its own rate of application. Accordingly, the amount of liquid impregnating composition applied to the particulate fertilizer in each application should be enough so that these rates of application match or at least are reasonably close to one another. In other words, each quantity of fertilizer to be applied to one acre of lawn should receive an amount of AAC appropriate for treating one acre of lawn. Thus, the amount of liquid impregnating composition to be used in each instance of the present invention can be easily calculated depending the target application rates of the fertilizer and AAC.

In general, this means that the impregnated product fertilizer produced by the present invention will contain as little as 0.01 wt. % to as much as 10 wt. % or more of the AAC. More typically, it will contain 0.1 to 2 wt. % ACC, or even 0.2 to 1 wt. % of the AAC. In addition, this product will also usually contain a small amount of the organic liquid carrier, typically in trace amounts or more, more normally about 0.01 wt. % to as much as 10 wt. % or more, more typically about 0.2 to 5 wt. % or even 1.5 wt. %.

### EXAMPLE

A mixture of 37.6 wt. % Prodiamine Technical Grade Herbicide (94.8% active) obtained from SipCam Aro USA of Roswell, Ga., and 62.4 wt. % M-Pyrol (N-methyl pyrrolidone) solvent obtained from ISP Technologies, Inc., of Wayne, N.J., was heated to about 75° C. (about 165° F.) with mechanical stirring until the prodiamine completely dissolved. The composition so obtained was then allowed to cool to ambient and then sprayed onto a moving bed of particulate fertilizer composed of a mixture of different fertilizer ingredients having particle sizes ranging from 4.75 to 1.18 mm, a combined bulk density of 0.92 gms/cc and containing about 24% nitrogen, 5% phosphorous and 11% potassium, measured as units of total nitrogen (N), available phosphate (P₂O₅) and soluble potash (K₂O).

The product fertilizer so obtained was then analyzed and was found to contain 0.45 wt % prodiamine and 0.78 wt. % N-methyl pyrrolidone.

Although only a few embodiments of the present invention have been described above, it should be appreciated that many modifications can be made without departing from the spirit and scope of the invention. All such modifications are intended to be included within the scope of the present invention, which is to be limited only by the following claims:

1. A process for producing a fertilizer impregnated with an agriculturally active chemical comprising contacting a particulate fertilizer with a liquid impregnating composition comprising at least 5 wt. % of the agriculturally active chemical dissolved in an organic liquid carrier having a flash point above ˜38° C. (100° F.) and exhibiting a Primary Irritation Score under 16 CFR 1500.3(c)(4) of 5 or less.

2. The process of claim 1, wherein the impregnating composition comprises at least 10 wt. % of the agriculturally active chemical and further wherein the organic liquid carrier exhibits a Primary Irritation Score under 16 CFR 1500.3(c)(4) of 1.5 or less.

3. The process of claim 2, wherein the organic liquid carrier is a pyrrolidone, lactone or mixtures thereof.

4. The process of claim 3, wherein the organic liquid carrier is N-methyl pyrrolidone, γ-butyrolactone or mixtures thereof.

5. The process of claim 4, wherein the organic liquid carrier is N-methyl pyrrolidone.

6. The process of claim 5, wherein the agriculturally active chemical is prodiamine.

7. The process of claim 6, wherein the liquid impregnating composition contains 10-50 wt. % prodiamine.

8. The process of claim 7, wherein the particulate fertilizer is a lawn fertilizer having a particle size of about 6.5 mm to 0.25 mm and a bulk density of about 0.05 to 1.5 gms/cc.

9. The process of claim 8, wherein the liquid impregnating composition is sprayed on the particulate fertilizer in an amount to provide a fertilizer product containing about 0.1 to 2 wt. % prodiamine.

10. A fertilizer product comprising a particulate fertilizer substrate impregnated with an agriculturally active chemical, the fertilizer product containing from a trace amount to about 10 wt. % of an organic liquid carrier capable of dissolving the agriculturally active chemical in a concentration of at least 5 wt. %, the organic liquid carrier having a flash point above ˜38° C. (100° F.) and exhibiting a Primary Irritation Score under 16 CFR 1500.3(c)(4) of 5 or less.

11. The fertilizer product of claim 10, wherein the fertilizer product contains about 0.01 wt. % to 5 wt. % of the organic liquid carrier.

12. The fertilizer product of claim 11, wherein the fertilizer product contains about 0.2 to 1.5 wt. % of the organic liquid carrier.

13. The fertilizer product of claim 10, wherein the organic liquid carrier is a pyrrolidone, lactone or mixtures thereof.

14. The fertilizer product of claim 13, wherein the organic liquid carrier is N-methyl pyrrolidone, γ-butyrolactone or mixtures thereof.

15. The fertilizer product of claim 14, wherein the organic liquid carrier is N-methyl pyrrolidone.

16. The fertilizer product of claim 15, wherein the agriculturally active chemical is prodiamine.

17. The fertilizer product of claim 16, wherein the fertilizer product contains about 0.1 to 2 wt. % prodiamine and about 0.2 to 1.5 wt. % N-methyl pyrrolidone.
